(19) United States
(12) Patent Application Publication
(10) Pub. No.: US 2004/0114676 A1
(43) Pub. Date: Jun. 17, 2004

(54) Upstream signal optimizer with a transmitter employing the same and a method of optimizing an upstream signal

(75) Inventors: Udayan Dasgupta, Irving, TX (US); Mustafa Turkboylari, Dallas, TX (US); Umashankar Iyer, Allen, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX (US)

(21) Appl. No.: 10/640,589

(22) Filed: Aug. 13, 2003

Related U.S. Application Data
(60) Provisional application No. 60/433,393, filed on Dec. 13, 2002.

(51) Int. Cl. H04B 1/38; H04L 5/16

(52) U.S. Cl. 375/222

(57) ABSTRACT

An upstream signal optimizer for use with a digital subscriber line (DSL) modem, a method of optimizing an upstream signal and a transmitter associated with a DSL modem. In one embodiment, the upstream signal optimizer includes (1) a signal adapter configured to shape a frequency domain of an upstream signal and (2) an adapter controller coupled to the signal adapter configured to control operation of the signal adapter based on a training sequence of the modem.

### CROSS-REFERENCE TO PROVISIONAL APPLICATION

This application claims the benefit of U.S. Provisional Application No. 60/433,393 entitled “FREQUENCY DOMAIN SPECTRAL SHAPING FOR ADSL” to Udayan Dasgupta, et al., filed on Dec. 13, 2002, which is incorporated herein by reference in its entirety.

### TECHNICAL FIELD OF THE INVENTION

The present invention is directed, in general, to a modem and, more specifically, to a digital subscriber line (DSL) modem that provides intelligent frequency domain spectral shaping.

### BACKGROUND OF THE INVENTION

Existing copper telephone wires, part of what is commonly referred to as the Plain Old Telephone System (POTS), provide more than just a medium for voice communication. Connected to a computer, telephone wires may provide a connection to other computers to, for instance, the Internet, thereby allowing data communication along with the voice communication. To provide the data communication, the digital data from the computers is converted to analog data for transmission across the telephone wires.

A modem may perform the data conversion from a digital domain to an analog domain as tones that can be transmitted over the telephone wires. A DSL modem is a common type of modem that uses sophisticated modulation schemes to load data onto the telephone wires. An Asymmetric DSL (ADSL) modem is a type of DSL modem that may supports data rates up to 12 Mbps when receiving data (known as the downstream rate) and up to one Mbps when transmitting data (known as the upstream rate).

Typically, an ADSL modem, which may be referred to generically as a remote terminal, transmits data upstream over the telephone wire to a Digital Subscriber Line Access Multiplier (DSLAM) at a central office of a telecommunications system via a central office ADSL modem coupled to the DSLAM. A common reason for the upstream instability between the ADSL modem and the central office ADSL modem is poor equalization of an upstream channel. The upstream channel may include the telephone wire in addition to front-end transmit filters of a transmitter of the ADSL modem and the front-end receive filters of the central office ADSL modem. The poor equalization may be a more noticeable problem when the ADSL modem and the central office ADSL modem are designed by a different manufacturer.

Typically, an upstream equalizer of the central office ADSL modem is sensitive to the transmit filters used at the transmitter of the ADSL modem. However, the transmit filters that are ideal for a given upstream equalizer, may not be the ideal transmit filters that optimally distribute transmit power for the best upstream and downstream data rate. Some upstream filters can optimally distribute upstream power but a time domain response of these upstream filters may effect equalization of the upstream channel thereby degrading upstream rates.

Accordingly, what is needed in the art is an improved ADSL modem that operates with enhanced upstream stability and data rate.

### SUMMARY OF THE INVENTION

To address the above-discussed deficiencies of the prior art, the present invention provides an upstream signal optimizer for use with a DSL modem, a method of optimizing an upstream signal and a transmitter associated with a DSL modem. In one embodiment, the upstream signal optimizer includes (1) a signal adapter configured to shape a frequency domain of an upstream signal and (2) an adapter controller coupled to the signal adapter configured to control operation of the signal adapter based on a training sequence of the modem.

In another aspect, the present invention provides a method of optimizing an upstream signal including (1) shaping a frequency domain of the upstream signal and (2) controlling the shaping based on a training sequence of the modem.

In yet another aspect, the present invention provides a transmitter associated with a DSL modem including (1) a front end coupled to a channel, (2) a digital-to-analog converter (DAC) coupled to the front end that converts an upstream signal from a digital domain to an analog domain for transmission on the channel and (3) a signal preparer coupled to the DAC that processes the upstream signal for the transmission including an upstream signal optimizer. The upstream signal optimizer includes (3a) a signal adapter that shapes a frequency domain of the upstream signal and (3b) an adapter controller coupled to the signal adapter that controls operation of the signal adapter based on a training sequence of the modem.

The present invention, therefore, allows employment of transmit filters that can be equalized by an equalizer at a central office and provide a signal shape optimal for data rates at the same time. A transmitter of a modem is provided that improves the interoperability performance between an upstream modem by advantageously changing a frequency domain shape of data, or upstream signal, to be transmitted upstream over a channel without changing a time domain response of the channel that is seen by an equalizer of the upstream modem during training. Uniquely, the present invention details a transmitter-only technique that achieves this objective. Additionally, this technique can also be used to trade-off upstream rate for better downstream rates by lowering a transmit echo. Moreover, the transmitter-only technique may compensate for a finite amount of pass-band ripple associated with digital and analog filters of the transmitter. Furthermore, the present invention may be used to compensate for distortions in the upstream signal due to impedance mismatches between a front end and a telephone line.

Thus, in general, the present invention may be used to compensate for several non-idealities in a signal path. In fact if a signal path can be estimated in real-time, frequency domain scaling coefficients can be generated on the fly, as part of an adaptive scheme to correct for process/component variations or line impedance changes. The signal path does not have to be an upstream signal but the present invention may also be employed by a DSLAM at a central office for downstream signals.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a transmitter constructed in accordance with the principles of the present invention;

FIG. 2 illustrates a block diagram of an embodiment of an upstream signal optimizer constructed in accordance with the principles of the present invention; and

FIG. 3 illustrates an embodiment of a flow diagram for a method of optimizing an upstream signal of a digital subscriber line (DSL) modem constructed in accordance with the principles of the present invention.

### DETAILED DESCRIPTION

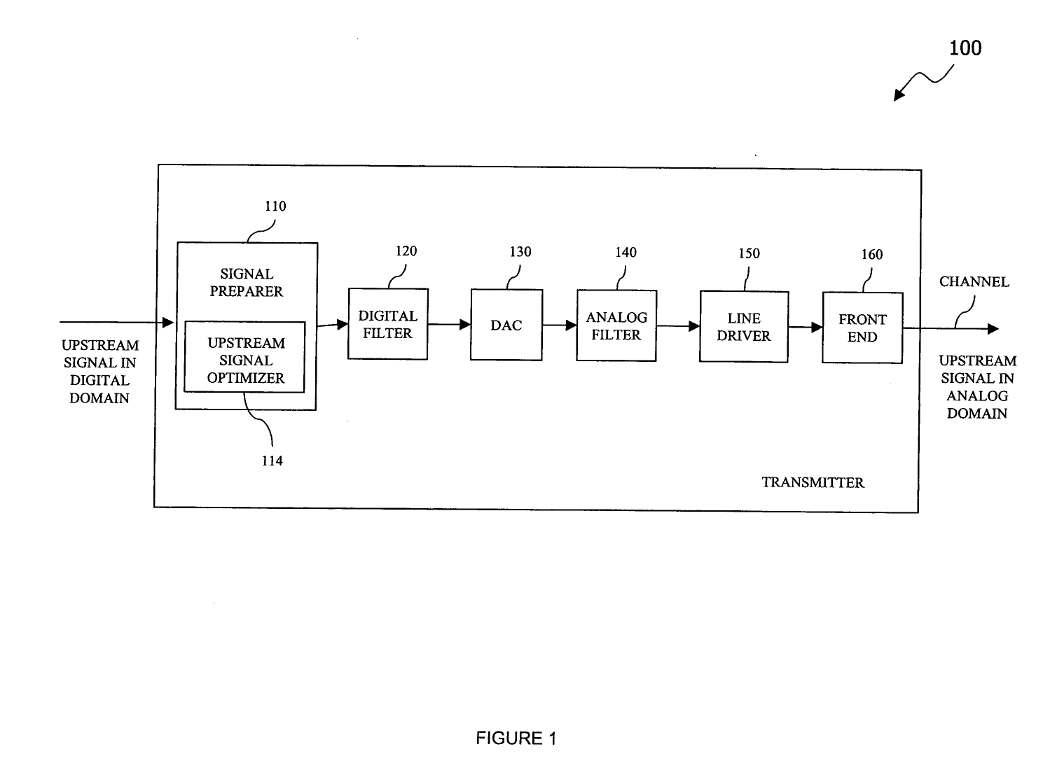

Referring initially to FIG. 1, illustrated is a block diagram of an embodiment of a transmitter, generally designated 100, constructed in accordance with the principles of the present invention. The transmitter 100 includes a signal preparer 110, a digital filter 120, a digital-to-analog converter (DAC) 130, an analog filter 140, a line driver 150 and a front end 160. The signal preparer includes a upstream signal optimizer 114.

The transmitter 100 may be employed within a remote DSL modem configured to transmit data to and receive data from a DSLAM (not referenced) via a central office modem (not referenced) over a channel. The transmitter 100 may receive the data to transmit, or the upstream signal, in a digital format from a conventional computer coupled to the remote DSL modem. Typically, the remote DSL modem may be a Frequency Division Duplexing (FDD) modem. In a preferred embodiment, the remote DSL modem is an Asymmetric DSL (ADSL) modem. Of course, one skilled in the art will understand that the transmitter 100 may be advantageously employed by other devices, instead of a modem, that transmits data over a channel.

The signal preparer 110 may receive the upstream signal for the transmitter 100 and process the upstream signal for transmission over the channel. In one embodiment, the signal preparer 110 may be a sequence of operating instructions employed on a digital signal processor (DSP). Processing by the signal preparer 110 may include, for example, converting the upstream signal from a frequency domain to a time domain employing an Inverse Fast Fourier Transform (IFFT), adding a cyclic prefix and modulating the upstream signal. The upstream optimizer 114 may provide additional processing and will be discussed in more detail below.

Coupled to the signal preparer 110 is the digital filter 120. The digital filter 120 may further process the upstream signal for transmission. The digital filter 120 may include several stages of filtering that are commonly employed within a DSL modem. Typically, the digital filter 120 includes interpolation filters to match a sampling rate of the DAC 130. Additionally, in a frequency division duplexing (FDD) system, a first interpolation filter may perform a band-split.

Coupled between the digital filter 120 and the analog filter 140, the DAC 130 converts the upstream signal from a digital domain to an analog domain for transmission over the channel. The DAC 130 may be a conventional DAC commonly employed within DSL modems. The analog filter 140 receives the upstream signal in the analog domain and performs additional filtering such as providing a desired out-of-band attenuation for transmit noise. The line driver 150 coupled to the analog filter 140 adjusts transmit power of the upstream signal to adhere to a given power spectral density (PSD) mask. The front end 160, coupled to the line driver 150 provides a connection to the channel for the transmitter 100. The front end 160 may include a transformer and coupling capacitors. One skilled in the art will understand the operation and configuration of the digital filter 120, the DAC 130, the analog filter 140 the line driver 150 and the front end 160.

Returning now to the signal preparer 110, the upstream signal optimizer 114 may provide additional processing of the upstream signal. The upstream signal optimizer 114 may change the PSD of the upstream signal to optimize an upstream data rate without changing the overall channel as viewed by an upstream equalizer at the central office modem. In a preferred embodiment, the upstream optimizer 114 may employ a signal adapter and an adapter controller to advantageously change the PSD by shaping a frequency domain of the upstream signal based on a training sequence of the remote DSL modem. Shaping of the frequency domain of the upstream signal may be performed by scaling data of the frequency domain employing a tone-dependent real number.

Typically, the remote DSL modem and the central office DSL modem cycle through a training sequence of pre-determined signals. The training sequence allows the DSL and the central office DSL modems to understand the capabilities of each end, analyze the channel for transmission, train algorithms included therein and estimate the signal-to-noise ratios (SNRs) and data rates that may be supported. In FDD modems, a typical training sequence may include, for example the following operations such as initial tone training, automatic gain control (AGC) training, timing acquisition, channel analysis, time domain equalizer (TEQ) training, frequency domain equalizer (FEQ) training, signal-to-noise (SNR) ratio estimation, and rate negotiation.

Typically, the timing acquisition is performed by the remote DSL modem although the central office DSL modem may perform the timing acquisition. Moreover, the AGC training of the remote DSL and central office DSL modems typically occur before a timing lock is established since training algorithms associated with the AGC training are mostly non-coherent in nature. Also, the channel analysis and TEQ training of the remote DSL and the central office DSL modem may be performed after the timing lock has been established. The TEQ may be sensitive to the channel seen by the central office modem and performance of the TEQ may degrade for certain transmit filters of the remote DSL modem. After completing the TEQ training, the remote DSL and the central office DSL modems may perform FEQ training which rotates constellations and compensates for power differences on tones of the upstream signal. The FEQ training typically employs an adaptive algorithm that continuously monitors slight changes of power between the tones of the upstream signal. Additionally, the remote DSL and the central office modems measure upstream/downstream SNRs and negotiate corresponding data rates. After the training sequence, the remote DSL and the central office DSL modem may exchange payload data, such as, the remote DSL modem transmitting the upstream signal.

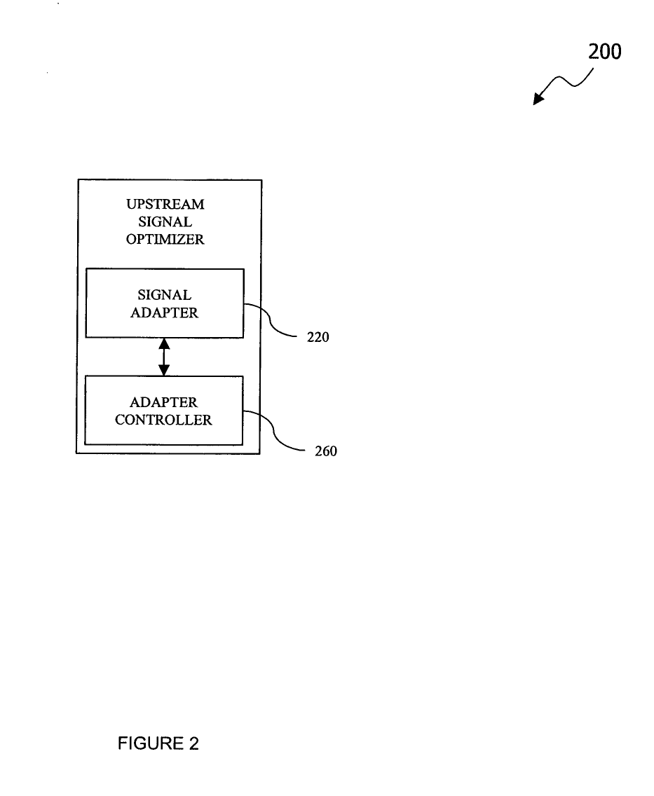

In some embodiments, the upstream signal optimizer 114 may provide frequency domain shaping of the upstream signal during AGC training, FEQ training and SNR ratio estimation. Additionally, the upstream signal optimizer 114 may provide the frequency domain shaping during transmission of the upstream signal, or payload data exchange, to the central office modem. Furthermore, the upstream signal optimizer 114 may refrain from the frequency domain shaping of the upstream signal during channel analysis and TEQ training of the remote DSL modem. Interoperability performance of the remote DSL modem and the central office modem, therefore, may be improved by controlling the frequency domain shaping of the upstream signal without changing a time domain of the channel that is seen by the upstream equalizer. Operation and configuration of the upstream signal optimizer 114 will discussed in more detail with respect to FIG. 2.

Turning now to FIG. 2, illustrated is a block diagram of an embodiment of an upstream signal optimizer, generally designated 200, constructed in accordance with the principles of the present invention. The upstream signal optimizer 200 includes a signal adapter 220 and an adapter controller 260.

The upstream signal optimizer 200 may be employed within a remote DSL modem coupled via a channel to a central office modem (not referenced) coupled to a DSLAM (not referenced). The upstream signal optimizer 200 may be a sequence of operating instructions configured to improve the interoperability of modems, such as the remote DSL modem and the central office modem, by changing the frequency domain shape of an upstream signal without changing a time domain of the channel as seen by an upstream equalizer, for example, at the central office modem. The upstream signal optimizer 200 may be employed on a DSP.

The signal adapter 220 may be configured to shape a frequency domain of the upstream signal. The signal adapter 220 may shape the frequency domain by scaling data thereof employing a tone-dependent real number. For example, after the upstream signal is generated in the frequency domain, a complex value on every tone of the upstream signal may be multiplied by a pre-determined real-valued scaling coefficient to provide a particular spectral shape to the upstream signal that may provide an optimum upstream data rate. The upstream signal may then be converted to a time domain, processed as desired and transmitted.

The adapter controller 260 coupled to the signal adapter 220 may be configured to control operation of the signal adapter 220 based on a training sequence of the remote DSL modem. Ideally, the adapter controller 260 enables the signal adapter 220 during certain operations of the training sequence. In one embodiment, the adapter controller 260 enables the signal adapter 220 during AGC training, FEQ training and SNR ratio estimation performed by the remote DSL modem. In alternative embodiments, the signal adapter 220 may also be enabled by the adapter controller 260 when the remote DSL modem is performing initial tone training, timing acquisition or rate negotiation.

The adapter controller 260 may also disable the signal adapter 220 during channel analysis and TEQ training performed by the remote DSL modem. By disabling the signal adapter 220 during these training sequence operations of the remote DSL modem, the central office modem during TEQ training does not consider the frequency domain shaping to be part of the spectral shape of the channel and adapt itself to equalize the modified channel. The upstream data rate, therefore, may be increased since an optimum frequency domain shape of the upstream signal may adversely effect equalization. Accordingly, during TEQ training, the channel without spectral shape changes may be equalized while during FEQ training, which usually employs an adaptive algorithm, changes in the spectral shape of the upstream signal may be considered. Additionally, if total power of the upstream signal is increased due to a change in the spectral shape, the AGC training at the central office modem may be allowed to train the spectral shape to prevent instabilities during payload data exchange due to clipping. Furthermore, desired SNRS may result when the frequency spectral shaping is enabled during the SNR ratio estimation.

Thus, the adapter controller 260 may advantageously enable the signal adapter 220 during the training sequence except during the TEQ training at the central office modem, for example, by the upstream equalizer. If the exact time of the TEQ training by the central office modem is not accurately known, the signal adapter 220 may be enabled during the central office modem's AGC training, FEQ training and SNR ratio estimation. The adapter controller 260 may ensure that the signal adapter 220 is enabled during AGC training but not during TEQ training of the central office modem based on the central office modem performing AGC training at the initial reception of a full band signal and performing TEQ training after the timing lock has been established. The adapter controller 260 may also ensure that the signal adapter 220 is enabled during and after SNR ratio estimation since ADSL modems typically employ MEDLEY transmitted signals during SNR ratio estimation and REVERB transmitted signals during the other operations of the training sequence.

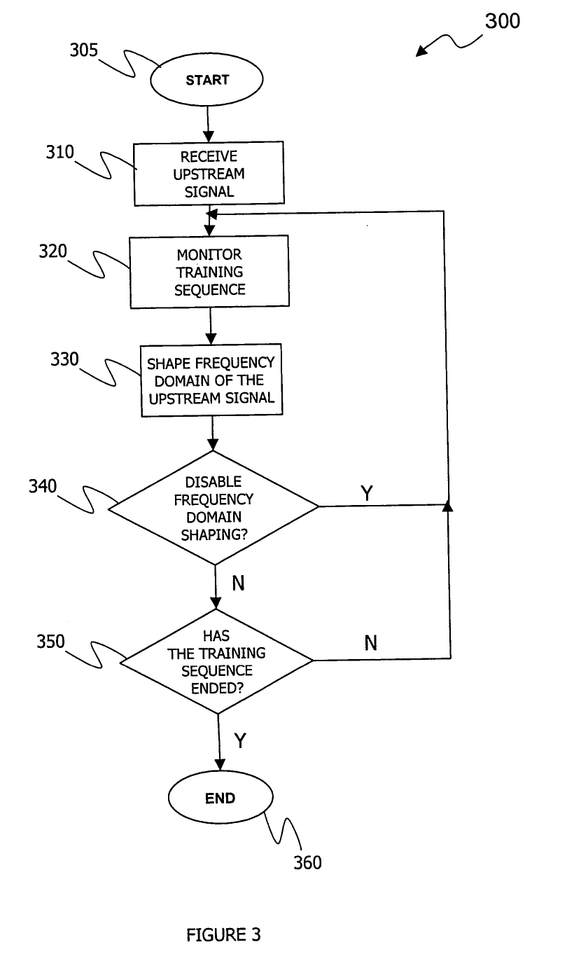

Turning now to FIG. 3, illustrated is an embodiment of a flow diagram for a method of optimizing an upstream signal of a DSL modem, generally designated 300, constructed in accordance with the principles of the present invention. The method 300 is triggered by an intent to optimize the upstream signal in a step 305.

After starting, the upstream signal is received in a step 310. The upstream signal, in a digital domain, may be received from a computer. Typically, the upstream signal is destined for transmission to a DSLAM coupled to a central office modem through a channel that includes telephone wire.

After receiving the upstream signal, a training sequence is monitored in a step 320. The training sequence may include operations such as initial tone training, AGC training, timing acquisition, channel analysis, TEQ training, FEQ training, SNR ratio estimation, and a rate negotiation. Typically the training sequence is between a remote DSL modem and a modem at a central office.

After monitoring the training sequence, a frequency domain of the upstream signal is shaped in a step 330. Frequency domain shaping may include scaling data of the upstream signal in the frequency domain by employing a tone-dependent real number. The scaling of data may be performed by a sequence of operating instructions employed within a digital signal processor (DSP).

After frequency domain shaping, the method determines to disable the frequency domain shaping based on the training sequence in a first decisional step 340. The frequency domain shaping may be disabled based on a training sequence operation of the DSL modem. For example, the frequency domain shaping may be disabled during channel analysis and TEQ training of the DSL modem. The disabling of the frequency domain shaping, therefore, may coincide with TEQ training of an upstream modem.

If the frequency domain shaping is not disabled, a determination is made if the training sequence has ended in a second decisional step 350. The training sequence may have ended after completion of the rate negotiation. If the training sequence has not ended, the method continues to step 320 and continues as described above. If the training sequence has ended, the method ends in a step 360. Returning now to the first decisional step 340, if the frequency domain shaping is disabled, the method continues to step 320 and continues to monitor the training sequence.

While the methods disclosed herein have been described and shown with reference to particular steps performed in a particular order, it will be understood that these steps may be combined, subdivided or reordered to form an equivalent method without departing from the teachings of the present invention. Accordingly, unless specifically indicated herein, the order and/or the grouping of the steps are not limitations of the present invention.

Although the present invention has been described in detail, those skilled in the art should understand that they can make various changes, substitutions and alterations herein without departing from the spirit and scope of the invention in its broadest form.

What is claimed is:

1. For use with a digital subscriber line (DSL) modem, an upstream signal optimizer, comprising:
a signal adapter configured to shape a frequency domain of an upstream signal; and
an adapter controller coupled to said signal adapter configured to control operation of said signal adapter based on a training sequence of said modem.

2. The upstream signal optimizer as recited in claim 1 wherein said signal adapter shapes said frequency domain by scaling data thereof employing a tone-dependent real number.

3. The upstream signal optimizer as recited in claim 1 wherein said training sequence includes operations selected from the group consisting of:
initial tone training,
automatic gain control training,
timing acquisition,
channel analysis,
time domain equalizer training,
frequency domain equalizer training,
signal-to-noise ratio estimation, and
rate negotiation.

4. The upstream signal optimizer as recited in claim 1 wherein said adapter controller disables said signal adapter during channel analysis and time domain equalizer training of said modem.

5. The upstream signal optimizer as recited in claim 1 wherein said upstream signal optimizer is employed on a digital signal processor.

6. The upstream signal optimizer as recited in claim 1 wherein said adapter controller enables said signal adapter during automatic gain control training, frequency domain equalizer training and signal-to-noise ratio estimation of said modem.

7. The upstream signal optimizer as recited in claim 1 wherein said adapter controller enables said signal adapter based on transmission of payload data.

8. A method of optimizing an upstream signal of a digital subscriber line (DSL) modem, comprising:
shaping a frequency domain of said upstream signal; and
controlling said shaping based on a training sequence of said modem.

9. The method of optimizing as recited in claim 8 wherein said shaping includes scaling data of said frequency domain employing a tone-dependent real number.

10. The method of optimizing as recited in claim 8 wherein said training sequence includes an operation selected from the group consisting of:
initial tone training,
automatic gain control training,
timing acquisition,
channel analysis,
time domain equalizer training,
frequency domain equalizer training,
signal-to-noise ratio estimation, and
rate negotiation.

11. The method of optimizing as recited in claim 8 further comprising disabling said signal adapter during channel analysis and time domain equalizer training of said modem.

12. The method of optimizing as recited in claim 8 wherein said method of optimizing includes employing a digital signal processor.

13. The method of optimizing as recited in claim 8 further comprising enabling said signal adapter during automatic gain control training, frequency domain equalizer training and signal-to-noise ratio estimation of said modem.

14. The method of optimizing as recited in claim 8 further comprising enabling said signal adapter based on transmission of payload data.

15. A transmitter associated with a digital subscriber line (DSL) modem, comprising:
a front end coupled to a channel;
a digital-to-analog converter (DAC) coupled to said front end that converts an upstream signal from a digital domain to an analog domain for transmission on said channel; and
a signal preparer coupled to said DAC that processes said upstream signal for said transmission including an upstream signal optimizer, including:
a signal adapter that shapes a frequency domain of said upstream signal; and
an adapter controller coupled to said signal adapter that controls operation of said signal adapter based on a training sequence of said modem.

16. The transmitter as recited in claim 15 wherein said signal adapter shapes said frequency domain by scaling data thereof employing a tone-dependent real number.

17. The transmitter as recited in claim 15 wherein said training sequence includes an operation selected from the group consisting of:
initial tone training,
automatic gain control training,
timing acquisition,
channel analysis,
time domain equalizer training,
frequency domain equalizer training,
signal-to-noise ratio estimation, and
rate negotiation.

18. The transmitter as recited in claim 15 wherein said adapter controller disables said signal adapter during a channel analysis and a time domain equalizer training of said modem.

19. The transmitter as recited in claim 15 wherein said upstream signal optimizer is employed on a digital signal processor.

20. The transmitter as recited in claim 15 wherein said adapter controller enables said signal adapter during automatic gain control training, frequency domain equalizer training and signal-to-noise ratio estimation of said modem.

21. The transmitter as recited in claim 15 wherein said adapter controller enables said signal adapter based on transmission of payload data.
